(19) United States
(12) Patent Application Publication
(10) Pub. No.: US 2025/0271108 A1
(43) Pub. Date: Aug. 28, 2025

(54) METHODS AND INTERNET OF THINGS (IOT) SYSTEMS FOR PIPELINE BLOCKAGE POINT LOCALIZATION OF SMART GAS AND MEDIA

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Lei ZHANG, Chengdu (CN); Yuefei WU, Chengdu (CN); Zhubin CHENG, Chengdu (CN)

(73) Assignee: CHENGDU QINCHUAN IOT TECHNOLOGY CO., LTD., Chengdu (CN)

(21) Appl. No.: 19/207,312

(22) Filed: May 13, 2025

(30) Foreign Application Priority Data
Apr. 17, 2025 (CN) 202510479983.X

(51) Int. Cl. F17D 5/00; F16L 55/26; F16L 101/12

(52) U.S. Cl. CPC F17D 5/005; F16L 55/26; F16L 2101/12

(57) ABSTRACT

Disclosed is a method and an Internet of Things (IoT) system or pipeline blockage point localization of smart gas and media. The method is implemented based on a gas company management platform of the IoT system for pipeline blockage point localization of smart gas, comprising: determining a monitoring point based on a historical blockage point set, the monitoring point being located in a gas pipeline of a gas pipeline network, the historical blockage point set being determined based on historical blockage data corresponding to a preset historical time period; constructing a gas operation map based on monitoring data corresponding to the monitoring point; determining a target blockage point location based on the gas operation map; determining a cleaning parameter based on the target blockage point location; and generating a cleaning instruction based on the cleaning parameter and sending the cleaning instruction to a cleaning robot.

### CROSS-REFERENCE TO RELATED APPLICATIONS

This application claims priority to Chinese Application No. 202510479983.X, filed on Apr. 17, 2025, the entire contents of which are incorporated herein by reference.

### TECHNICAL FIELD

The present disclosure relates to a field of pipeline monitoring, and in particular to a method and an Internet of Things (IoT) system for pipeline blockage point localization of smart gas and a medium.

### BACKGROUND

With the acceleration of urbanization, the scale and complexity of the gas pipeline network continue to increase, making the detection and resolution of pipeline blockage increasingly critical. The blockage in a gas pipeline not only disrupts normal gas supply but may also pose safety hazards. Traditional detection processes, such as manual inspection, hardware-based detection, and software-based detection can detect and address blockage issues to some extent. However, they suffer from limitations such as low efficiency, high costs, and insufficient real-time performance. Accordingly, there is an urgent need to develop more efficient and intelligent detection techniques to conduct timely pipeline detection and cleaning of the pipeline.

To address pipeline blockage detection, CN103644457B proposes a method and device for pipeline blockage localization. The device primarily generates infrasound waves within the pipeline, and detects and locate the blockage using the propagation characteristics. However, an infrasound sensor may be susceptible to environmental noise interference, which may compromise the accurate detection of acoustic signals and consequently affect the accuracy of blockage localization.

Therefore, it is desirable to provide a method and an Internet of Things (IoT) system for pipeline blockage point localization of smart gas and a medium to carry out efficient and accurate detection of the gas pipeline blockage, thereby improving the safety operation of the urban gas pipeline network.

### SUMMARY

One of the embodiments of the present disclosure provides a method for pipeline blockage point localization of smart gas, implemented based on a gas company management platform of an Internet of Things (IoT) system for pipeline blockage point localization of smart gas, comprising: determining a monitoring point based on a historical blockage point set, the monitoring point being located in a gas pipeline of a gas pipeline network, the historical blockage point set being determined based on historical blockage data corresponding to a preset historical time period; constructing a gas operation map based on monitoring data corresponding to the monitoring point, the monitoring data including at least one of a pipeline pressure and a gas flow rate; determining a target blockage point location based on the gas operation map; determining a cleaning parameter based on the target blockage point location, the cleaning parameter including at least one point location to be cleaned; and generating a cleaning instruction based on the cleaning parameter and sending the cleaning instruction to a cleaning robot to clean a gas pipeline corresponding to the at least one point location to be cleaned.

One of the embodiments of the present disclosure provides an Internet of Things (IoT) system for pipeline blockage point localization of smart gas, comprising a government safety supervision management platform, a government safety supervision sensor network platform, a gas company management platform, a gas company sensor network platform, and a smart gas equipment object platform. The smart gas equipment object platform may include a cleaning robot and a monitoring device. The cleaning robot may be configured to clean a gas pipeline of a gas pipeline network. The monitoring device may be configured at a location of a monitoring point in the gas pipeline for obtaining monitoring data corresponding to the monitoring point, the monitoring point being located in the gas pipeline of the gas pipeline network. The gas company management platform may be configured to: obtain the monitoring data corresponding to the monitoring point from the smart gas equipment object platform through the gas company sensor network platform, and upload the monitoring data to the government safety supervision management platform through the government safety supervision sensor network platform; construct a gas operation map based on the monitoring data corresponding to the monitoring point, the monitoring data including at least one of a pipeline pressure and a gas flow rate; determine a target blockage point location based on the gas operation map; determine a cleaning parameter based on the target blockage point location, the cleaning parameter including at least one point location to be cleaned; and generate a cleaning instruction based on the cleaning parameter and send the cleaning instruction to the cleaning robot through the smart gas equipment object platform to clean a gas pipeline corresponding to the at least one point location to be cleaned.

One of the embodiments of the present disclosure provides a non-transitory computer-readable storage medium. The non-transitory computer-readable storage medium may comprise computer instructions that, when executed by a computer, direct the computer to implement the method for pipeline blockage point localization of smart gas.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an exemplary platform structure of an Internet of Things (IoT) system for pipeline blockage point localization of smart gas according to some embodiments of the present disclosure;

FIG. 2 is a flowchart illustrating an exemplary method for pipeline blockage point localization of smart gas according to some embodiments of the present disclosure;

FIG. 3 is a schematic diagram illustrating a process of determining a blockage point location according to some embodiments of the present disclosure;

FIG. 4 is a flowchart illustrating a process of determining a cleaning parameter according to some embodiments of the present disclosure; and

FIG. 5 is a schematic diagram illustrating an effect determination model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind”, and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure It should be appreciated that the preceding or following operations are not necessarily performed in an exact sequence. Instead, steps can be processed in reverse order or simultaneously. Also, it is possible to add other operations to these processes or to remove a step or steps from these processes.

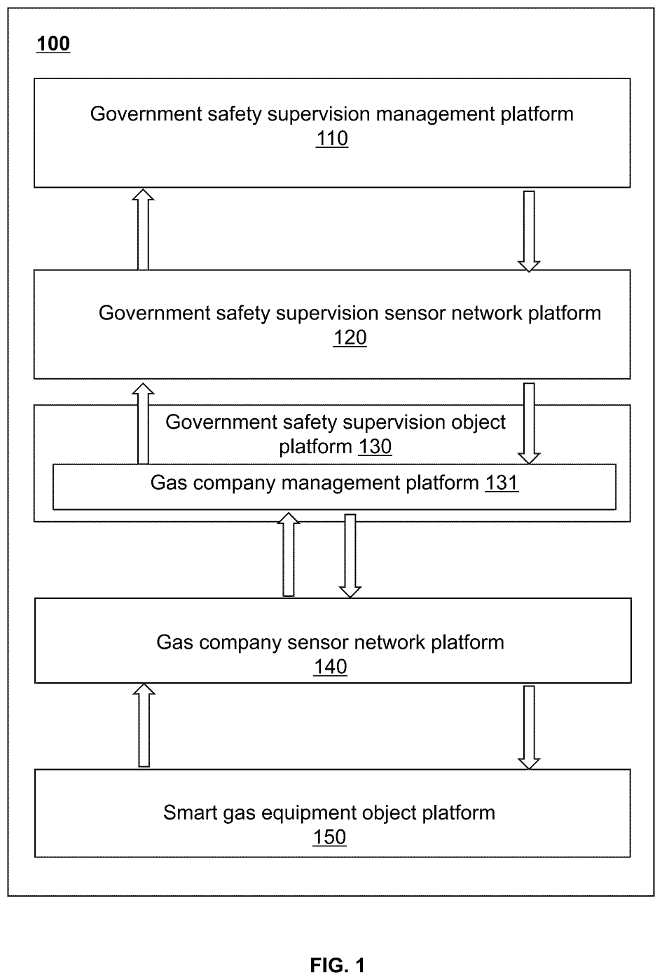

FIG. 1 is a schematic diagram illustrating an exemplary platform structure of an Internet of Things (IoT) system for pipeline blockage point localization of smart gas according to some embodiments of the present disclosure. A blockage point refers to a point location where there is a blockage in a gas pipeline. In some embodiments of the present disclosure, the blockage point is also referred to as a blockage point location.

As shown in FIG. 1, an IoT system for pipeline blockage point localization of smart gas 100 may include a government safety supervision management platform 110, a government safety supervision sensor network platform 120, a gas company management platform 131, a gas company sensor network platform 140, and a smart gas equipment object platform 150.

The government safety supervision management platform 110 refers to a platform for supervision and safety management of the gas pipeline. In some embodiments, the government safety supervision management platform 110 may be configured in a processor and/or a server for integrating and coordinating the connection and collaboration between functional platforms, and aggregating all IoT information, providing perception management and control management functions for an IoT operation system.

In some embodiments, the government safety supervision management platform 110 may perform data interaction with the government safety supervision sensor network platform 120.

The government safety supervision sensor network platform 120 refers to a functional platform for managing sensor communication for a government. In some embodiments, the government safety supervision sensor network platform 120 may be configured as a communication network, gateway, etc. and may be configured to realize functions of perceptual information sensor communication and control information sensor communication.

In some embodiments, the government safety supervision sensor network platform 120 may perform upward interaction with the government safety supervision management platform 110 and downward interaction with a gas company management platform 131. For example, the gas company management platform 131 may send data related to gas pipeline blockage point localization to the government safety supervision management platform 110 via the government safety supervision sensor network platform 120.

A government safety supervision object platform 130 is an object platform for sensor information generation and control information execution.

In some embodiments, the government safety supervision object platform 130 may perform upward interaction with the government safety supervision sensor network platform 120 and downward interaction with the gas company sensor network platform 140.

The gas company management platform 131 refers to a comprehensive management platform for information related to the gas company. In some embodiments, the gas company management platform 131 may be configured to perform the method for pipeline blockage point localization of smart gas. More descriptions regarding the method for pipeline blockage point localization of smart gas may be found in the present disclosure below.

In some embodiments, the gas company management platform 131 may further include a processor. The processor may be configured to process data and/or information obtained from other platforms. The processor may execute program instructions based on the data, the information, and/or processing results to perform one or more of the functions described in the present disclosure.

The gas company sensor network platform 140 refers to a comprehensive management platform for sensor information related to the gas company. In some embodiments, the gas company sensor network platform 140 may be configured as a communication network, gateway, etc. and may be configured to realize functions of perceptual information sensor communication and control information sensor communication.

In some embodiments, the gas company sensor network platform 140 may perform upward interaction with the gas company management platform 131 and downward interaction with the smart gas equipment object platform 150. For example, the gas company management platform 131 may upload, via the gas company sensor network platform 140, monitoring data corresponding to a monitoring point obtained by the smart gas equipment object platform 150 to the government safety supervision management platform 110.

The smart gas equipment object platform 150 refers to a functional platform that executes a cleaning instruction and obtains cleaning data. In some embodiments, the smart gas equipment object platform 150 may include at least one pipeline cleaning device and at least one pipeline monitoring device.

The pipeline cleaning device refers to a functional device for cleaning inside the gas pipeline, such as a cleaning robot, etc. In some embodiments, the pipeline cleaning device may be configured to clean the gas pipeline.

The pipeline monitoring device refers to a functional device for monitoring a blockage inside the gas pipeline, such as a pressure sensor, a flow sensor, a blockage detector, etc. In some embodiments, the pipeline monitoring device may be configured to monitor the blockage inside the gas pipeline.

In some embodiments, the smart gas equipment object platform 150 may perform data interaction with the gas company management platform 131 via the gas company sensor network platform 140.

In some embodiments, the platforms of the IoT system for pipeline blockage point localization of smart gas 100 may be divided into a smart gas primary network and a smart gas secondary network. The smart gas primary network refers to a network in which a government user supervises operation of the gas pipeline network. The smart gas secondary network refers to a network that includes the operation of the gas pipeline network. In some embodiments, the same platform of the IoT system for pipeline blockage point localization of smart gas 100 may assume different roles in the smart gas primary network and the smart gas secondary network.

In some embodiments, the smart gas primary network may include at least a smart gas primary network management platform, a smart gas primary network sensor network platform, and a smart gas primary network object platform. The smart gas primary network management platform may include the government safety supervision management platform, the smart gas primary network sensor network platform may include the government safety supervision sensor network platform, and the smart gas primary network object platform may include the government safety supervision object platform. The government safety supervision object platform may be the gas company management platform.

In some embodiments, the smart gas secondary network may include at least a smart gas secondary network management platform, a smart gas secondary network sensor network platform, and a smart gas secondary network object platform. The smart gas secondary network management platform may include the gas company management platform, the smart gas secondary network sensor network platform may include the gas company sensor network platform, and the smart gas secondary network object platform may include the smart gas equipment object platform.

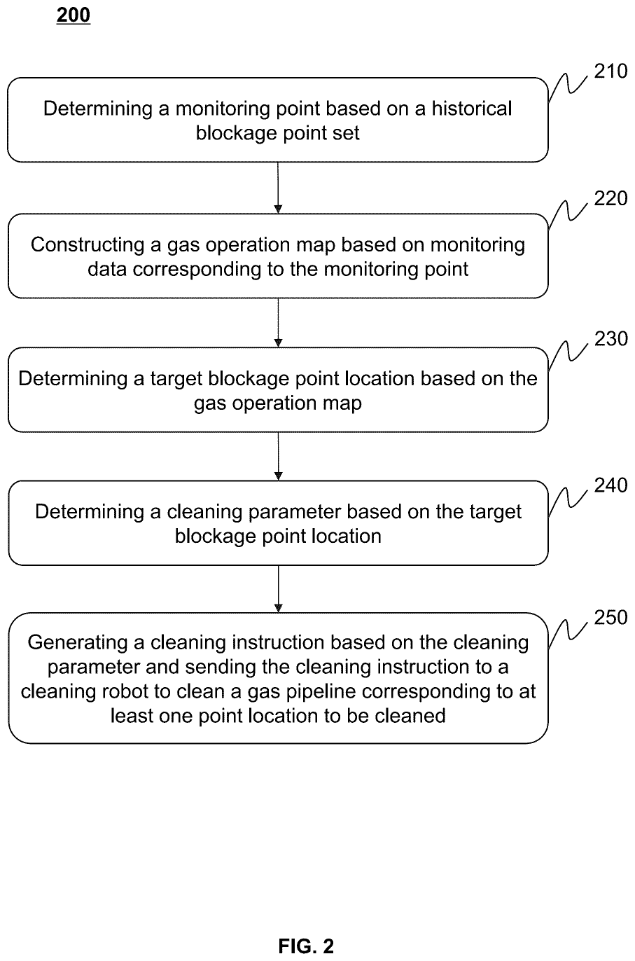

More descriptions regarding the execution function of the IoT system for pipeline blockage point localization of smart gas 100 may be found in FIGS. 2-5 and the related descriptions thereof.

According to some embodiments of the present disclosure, the IoT system for pipeline blockage point localization of smart gas 100 can form a closed loop of information operation between various platforms, and coordinate and regularize the operation under the unified management of the gas company management platform to realize the intellectualization and standardization of the process of the pipeline blockage point localization.

In some embodiments, when the method for pipeline blockage point localization of smart gas is implemented, the gas company management platform may determine a monitoring point based on a historical blockage point set; construct a gas operation map based on monitoring data corresponding to the monitoring point; determine a target blockage point location based on the gas operation map; determine a cleaning parameter based on the target blockage point location; and generate a cleaning instruction based on the cleaning parameter and send the cleaning instruction to the cleaning robot to clean a gas pipeline corresponding to at least one point location to be cleaned.

FIG. 2 is a flowchart illustrating an exemplary method for pipeline blockage point localization of smart gas according to some embodiments of the present disclosure. As shown in FIG. 2, a process 200 may include the following operations. In some embodiments, the process 200 may be performed by a gas company management platform.

In 210, a monitoring point may be determined based on a historical blockage point set.

The monitoring point refers to a monitoring point location where a monitoring device is arranged. In some embodiments, the monitoring point may be located in a gas pipeline of a gas pipeline network, such as a bifurcation, a junction, a bend, or a special facility (e.g., a filtration facility, a pressure regulation facility, etc.) of the gas pipeline.

In some embodiments, the gas company management platform may determine the monitoring point based on the historical blockage point set.

The historical blockage point set refers to a set of all historical blockage point locations in a preset historical time period. A blockage point location refers to a point location in the gas pipeline where a blockage event occurs. For example, the blockage point location may include a main pipeline, a pipeline branch, and a pipeline interface, or the like. The historical blockage point location is a point location in historical data where the blockage event occurs in the gas pipeline. In some embodiments, the blockage point location, and the historical blockage point location may be represented by coordinates, where the coordinates may include, but are not limited to, at least one of geographic coordinate and customized coordinate.

In some embodiments, the historical blockage point set may be determined by the gas company management platform based on historical blockage data corresponding to the preset historical time period. The preset historical time period may be set based on prior experience and/or actual needs.

The historical blockage data refers to all relevant information and data related to the blockage event that occurs in the IoT system for pipeline blockage point localization of smart gas in a past period of time. For example, the historical blockage data may include historical blockage point locations in a historical time period.

In some embodiments, the historical blockage point locations may be obtained in a variety of ways, such as manual monitoring, using a pipe crawling robot, or the like.

In some embodiments, a duration of the preset historical time period may be determined based on an accident feature of a preset historical accident inside the gas pipeline.

The preset historical accident refers to an accident whose historical frequency of occurrence satisfies a preset frequency condition. The preset frequency condition may include a highest historical frequency of occurrence, a historical frequency of occurrence being higher than a frequency threshold, etc. The frequency threshold may be determined based on prior experience.

The accident feature refers to an identifiable property related to a gas pipeline accident. For example, the accident feature may include, but is not limited to, at least one of whether a blockage point is easy to monitor, a count of times of monitoring, a count of accidents, and a cause of the accident.

The preset historical accident and the corresponding accident feature reflect an overall situation of the gas pipeline. For example, if the accident feature corresponding to the preset historical accident indicates that the accident is caused by a component issue, it is inferred that the gas pipeline corresponding to the preset historical accident is old. As another example, if the accident feature corresponding to the preset historical accident indicates that the accident is easy to monitor, it is determined that the gas pipeline corresponding to the preset historical accident is not susceptible to accident leakage.

In some embodiments, if the preset historical accident corresponding to the gas pipeline is easy to monitor, a shorter preset historical duration may be set for the gas pipeline to reduce the amount of data processing and increase the efficiency of data processing; if the preset historical accident corresponding to the gas pipeline is not easy to monitor, a longer preset historical duration may be set for the gas pipeline to obtain sufficient data so as to more accurately analyze the blockage of the gas pipeline.

In some embodiments, the gas company management platform may determine the monitoring point based on a cleaning frequency of each historical blockage point location in the historical blockage point set. For example, the gas company management platform may determine the cleaning frequency of each historical blockage point location, and count point locations with cleaning frequencies greater than a cleaning threshold as the monitoring points. The cleaning threshold refers to a critical value of the cleaning frequency, which may be determined based on prior experience.

In some embodiments, the cleaning frequency of the historical blockage point location is related to a count of times that the historical blockage point location is cleaned per unit of historical time. For example, the gas company management platform may determine the cleaning frequency by the following equation (1):

$$F = N / T \qquad ( 1 )$$

where F denotes the cleaning frequency, T denotes the preset historical time period, and N denotes the count of times that the historical blockage point location is cleaned.

In some embodiments, the gas company management platform may selectively enable the monitoring device. When the cleaning frequency of the historical blockage point location is greater than the cleaning threshold, it is necessary to focus on the monitoring of the historical blockage point location. In this case, the gas company management platform may take the historical blockage point location with the cleaning frequency greater than the cleaning threshold as the monitoring point, and turn on the monitoring device corresponding to the historical blockage point location.

By selectively enabling monitoring device, it is possible to improve the data quality of the monitoring data and reduce the amount of invalid data, thereby improving the operational efficiency of the system.

In 220, a gas operation map may be constructed based on monitoring data corresponding to the monitoring point.

The gas operation map refers to a map which reflects an actual positional relationship between monitoring points, pipeline nodes, and pipelines.

In some embodiments, the gas operation map may include nodes and edges.

The nodes of the gas operation map may be configured to characterize the monitoring points and the pipeline nodes in the gas pipeline network. The monitoring points refer to point locations where the monitoring devices are provided. The pipeline nodes refer to key parts in the pipeline system. The key parts refer to parts of the gas pipeline network that have a significant impact on the safety operation of the gas pipeline network, which may include, but are not limited to, a bifurcation, a junction, a bend, and a special facility (e.g., a filtration facility, a pressure regulation facility, etc.) of the pipeline.

In some embodiments, the nodes of the gas operation map have a node attribute. For example, for a node corresponding to the monitoring point, the node attribute may include the monitoring data which may be obtained by the monitoring device provided at the monitoring point, and may include, but is not limited to, at least one of a pipeline pressure, and a gas flow rate; as another example, for a node corresponding to the pipeline node, the node attribute may include a type of the pipeline node, where the type of the pipeline node may include, but is not limited to, the bifurcation, the junction, the bend, and the special facility (e.g., the filtration facility, the pressure regulation facility, etc.) of the pipeline, which may be determined according to the actual situation of the pipeline node.

The edges of the gas operation map may be configured to characterize gas pipelines connecting different nodes. In some embodiments, the edges of the gas operation map have an edge attribute, and the edge attribute may be configured to characterize a feature of the gas pipeline. For example, the edge attribute may include, but is not limited to, a pipeline length. The pipeline length may be obtained from a government safety supervision management platform.

In some embodiments, the gas company management platform may construct the gas operation map based on the gas pipeline network, the key parts in the gas pipeline network, the monitoring points, and the monitoring data corresponding to the monitoring points. For example, the gas company management platform may obtain a constructed gas operation map by taking the monitoring points and the pipeline nodes in the gas pipeline network as the nodes of the gas operation map, taking the monitoring data corresponding to the monitoring points and the type of the pipeline nodes as the node attributes, taking the gas pipelines connecting the nodes as the edges of the gas operation map, and taking the length of the gas pipeline between the nodes as the edge attribute.

In 230, a target blockage point location may be determined based on the gas operation map.

The target blockage point location refers to a point location that requires focus and cleaning measures.

In some embodiments, the gas company management platform may determine, based on the gas operation map, the target blockage point location in a plurality of ways. For example, the gas company management platform may determine a node in the gas operation map that satisfies a preset condition as the target blockage point location. The preset condition may include that the nodes has corresponding monitoring data, a pipeline pressure of a pipeline where the node is located is greater than a pressure threshold, and a gas flow rate is less than a flow rate threshold. The pressure threshold and the flow rate threshold may be determined based on prior experience.

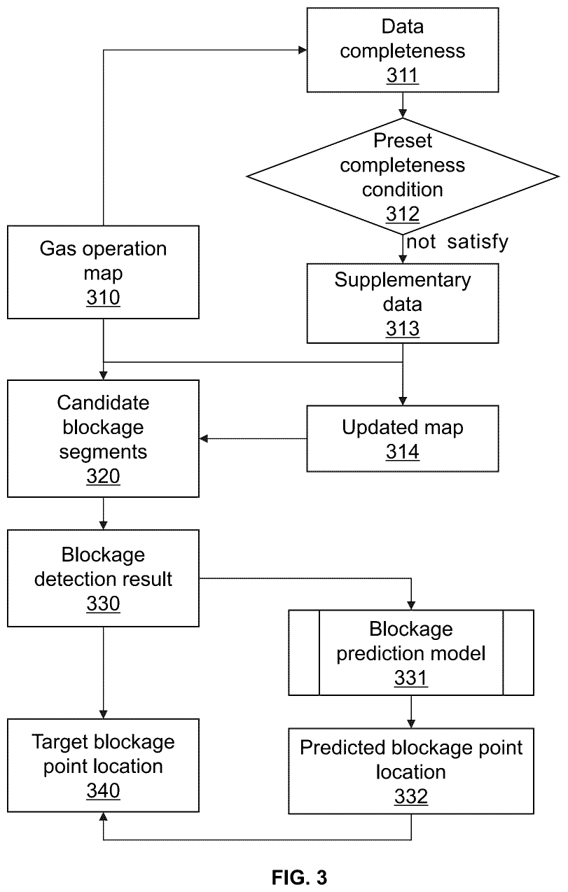

In some embodiments, the gas company management platform may determine candidate blockage segments based on the gas operation map; obtain a blockage detection result of the candidate blockage segments; and determine the target blockage point location based on the blockage detection result. More descriptions may be found in FIG. 3 of the present disclosure and the related descriptions thereof.

In 240, a cleaning parameter may be determined based on the target blockage point location.

In some embodiments, the cleaning parameter refers to a parameter that measures the cleaning performance of the cleaning robot when performing pipeline cleaning.

In some embodiments, the cleaning parameter may include at least one point location to be cleaned. The at least one point location to be cleaned refers to a location in the gas pipeline that needs to be cleaned.

In some embodiments, the cleaning parameter may further include a movement speed of the cleaning robot, a cleaning intensity, a sweeping tool, etc. In some embodiments, the gas company management platform may classify the cleaning parameter into different types based on parameter items corresponding to the cleaning parameter. For example, the cleaning parameter may be classified into a movement parameter, a configuration parameter, etc. The movement parameter may include the at least one point location to be cleaned and the movement speed. The configuration parameter may include the cleaning intensity and the sweeping tool. The movement parameter and the configuration parameter may further include other types of parameters, which may be determined according to the actual situation of the cleaning robot.

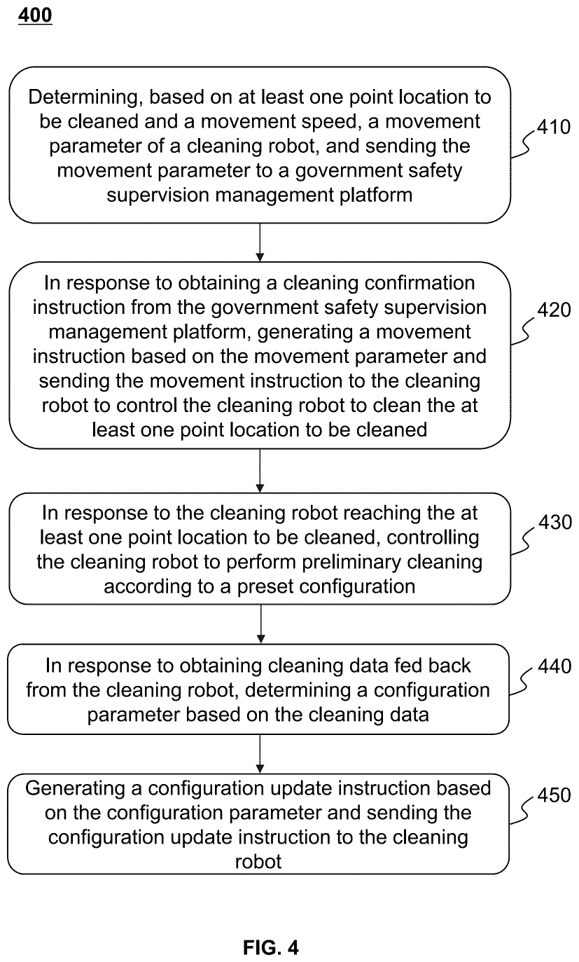

More descriptions regarding the movement parameter, the configuration parameter, the movement speed, the cleaning intensity, and the sweeping tool may be found in FIG. 4 and the related descriptions thereof.

In some embodiments, the gas company management platform may determine the cleaning parameter based on the target blockage point location. For example, the gas company management platform may determine the cleaning parameter by taking the target blockage point location as the point location to be cleaned.

In some embodiments, the gas company management platform may determine the movement parameter based on the at least one point location to be cleaned and the movement speed, and determine the configuration parameter based on the cleaning data.

More descriptions regarding the cleaning data and determining the movement parameter, the configuration parameter, the movement speed, the cleaning intensity, and the sweeping tool may be found in FIG. 4 and the related descriptions thereof.

In 250, a cleaning instruction may be generated based on the cleaning parameter, and the cleaning instruction may be sent to a cleaning robot to clean a gas pipeline corresponding to at least one point location to be cleaned.

The cleaning instruction refers to a series of specific operational commands sent by the gas company management platform to guide the cleaning robot or the cleaning device to perform a specific cleaning task during pipeline cleaning operation. In some embodiments, the cleaning instruction may include the cleaning parameter. In some embodiments, the cleaning instruction may be classified into a movement instruction and a configuration instruction according to a specific content of the cleaning instruction. The movement instruction may be configured to control the movement of the cleaning robot. The configuration instruction may be configured to control the cleaning intensity of the cleaning robot and the sweeping tool provided on the cleaning robot. More descriptions regarding the cleaning instruction may be found in FIG. 4 and the related descriptions thereof.

In some embodiments, the gas company management platform may generate the cleaning instruction based on the cleaning parameter. For example, the gas company management platform may generate the cleaning instruction that includes the cleaning parameter, such as cleaning the at least one point location to be cleaned in the gas pipeline, etc.

In some embodiments, the gas company management platform may transmit the cleaning instruction to the smart gas equipment object platform by the gas company sensor network platform to control the cleaning robot in the smart gas equipment object platform to clean the gas pipeline according to the cleaning parameter.

The gas pipeline may form accumulated impurities caused at a blockage point due to gas impurities, corrosion of the pipeline, and entry of foreign objects, which may interfere with the normal flow of gas. In some embodiments of the present disclosure, the gas company management platform determines the monitoring point through the historical blockage point locations, collects the monitoring data to construct the gas operation map, and accurately determine the blockage point location and clean the blockage point location in time to effectively prevent formation of the blockage point, thereby promoting the normal gas flow, and reducing pipeline risks.

It should be noted that the foregoing description of the process 200 is intended to be merely exemplary and illustrative, and does not limit the scope of application of the present disclosure. For a person skilled in the art, various corrections and changes can be made to the process 200 under the guidance of the present disclosure. However, these corrections and changes remain within the scope of the present disclosure.

FIG. 3 is a schematic diagram illustrating a process of determining a blockage point location according to some embodiments of the present disclosure.

As shown in FIG. 3, in some embodiments, the gas company management platform may determine candidate blockage segments 320 based on a gas operation map 310; obtain a blockage detection result 330 of the candidate blockage segments 320; and determine a target blockage point location 340 based on the blockage detection result 330.

The candidate blockage segments refer to pipeline segments that may have blockage points. In some embodiments, the candidate blockage segments may include at least one pipeline segment that may have a blockage point.

The candidate blockage segments may be determined in a plurality of ways. In some embodiments, the gas company management platform may determine the candidate blockage segments based on the gas operation map. For example, the gas company management platform may determine a pipeline where a node that satisfies a preset condition is located, and upstream and downstream gas pipelines of the node as the candidate blockage segments. The preset condition may include that the node has corresponding monitoring data, a pipeline pressure of the pipeline where the node is located is greater than a pressure threshold, and a gas flow rate being less than a flow rate threshold.

In some embodiments, the gas company management platform may evaluate data completeness 311 of the gas operation map 310, in response to determining that the data completeness 311 does not satisfy a preset completeness condition 312: determine a data request and send the data request to the government safety supervision management platform to obtain supplementary data 313; obtain an updated map 314 by updating the gas operation map based on an obtaining condition of the supplementary data; and determine the candidate blockage segments 320 based on the updated map 314.

In some cases, due to data permissions, untimely data acquisition, or other possible reasons, the government safety supervision management platform is unable to send all the data required for constructing the gas operation map to the gas company management platform. In this case, the gas company management platform may first construct the gas operation map based on the acquired data, and then determine whether to further acquire data from the government safety supervision management platform by evaluating the data completeness.

The data completeness is a value that characterizes a level of completeness of attribute data corresponding to a node in a gas operation map. The higher the data completeness, the better the attribute data corresponding to the node in the gas operation map.

In some embodiments, the data completeness may include a level of completeness of detection data corresponding to a monitoring point in the gas operation map. For example, the gas company management platform may evaluate the data completeness of the gas operation map based on a count of nodes in the gas operation map that have the monitoring data and a total count of nodes that characterize the monitoring points in the gas operation map. The higher the count of nodes that have the monitoring data, the higher the data completeness. For example, the data completeness is determined based on a percentage of the count of nodes that have the monitoring data to the total count of nodes that characterize the monitoring points.

In some embodiments, the preset completeness condition may be that the data completeness is not less than a completeness threshold.

The completeness threshold refers to a numerical value that characterizes a minimum standard of data completeness. In some embodiments, the completeness threshold may be set based on prior experience and/or actual needs.

In some embodiments, the completeness threshold may be positively correlated to an area of a region where the gas pipeline network is located. For example, the larger the area of the region where the gas pipeline network is located, the higher the completeness threshold. In some embodiments, the area of the region where the gas pipeline network is located may be obtained by the gas company management platform from the government safety supervision management platform via the government safety supervision sensor network platform.

Since the larger the area, the wider the range of pipelines in the region, the comprehensiveness of the data can be improved by setting the completeness threshold that is positively correlated with the area, thereby more accurately determining the blockage of the gas pipeline network.

In some embodiments, in response to determining that the data completeness of the gas operation map does not satisfy a preset completeness condition, the gas company management platform may determine the data request and send the data request to the government safety supervision management platform by the government safety supervision sensor network platform.

The data request refers to information used to apply for the supplementary data.

The supplementary data is data used to supplement a missing node attribute in the gas operation map. In some embodiments, the supplementary data may be used to improve the data completeness of existing monitoring data.

In some embodiments, the gas company management platform may send the data request to the government safety supervision management platform via the government safety supervision sensor network platform to request for obtaining the supplementary data.

In some embodiments, the gas company management platform may obtain the updated map by updating the gas operation map based on the obtaining condition of the supplementary data.

The updated map refers to a new gas operation map obtained by refining the missing node attribute in the gas operation map. The missing node attribute refers to missing monitoring data of the node corresponding to the monitoring point in the gas operation map.

In some embodiments, in response to obtaining the supplementary data, the gas company management platform may obtain the updated gas operation map by updating the gas operation map based on the supplementary data. For example, the gas company management platform may supplement, based on the supplementary data, the missing node attribute in the gas operation map. In response to determining that the data completeness of the gas operation map after data supplementing satisfies the preset completeness condition, the gas company management platform may determine the gas operation map after data supplementing as the updated map.

In some embodiments, in response to determining that the data completeness of the gas operation map after data supplementing does not satisfy the preset completeness condition, the gas company management platform may process the gas operation map after data supplementing by a preset manner, determine an estimated value of the missing monitoring data, and further improve the gas operation map based on the estimated value to obtain the updated map. The preset manner may be interpolation. More descriptions regarding the interpolation may be found in the present disclosure below.

In some embodiments, in response to not obtaining the supplementary data, the gas company management platform may determine estimated monitoring data based on the gas operation map; and obtain the updated gas operation map by updating the gas operation map based on the estimated monitoring data.

The estimated monitoring data refers to an estimated value of the missing monitoring data in the gas operation map. For example, the estimated monitoring data may include an estimated value of the node without monitoring data.

In some embodiments, the gas company management platform may determine the estimated monitoring data based on the gas operation map by a preset manner. The preset manner may be interpolation.

In some embodiments, determining the estimated monitoring data by the interpolation may include: the gas company management platform obtaining actual position coordinates of the nodes in the gas operation map, determining a plurality of discrete points based on the nodes having the monitoring data, and perform interpolation calculation based on the plurality of discrete points to obtain the estimated monitoring data corresponding to the nodes without monitoring data.

The interpolation may include a variety of types, including, for example, at least one of Lagrangian algorithm and Newton interpolation, and may include other algorithms capable of implementing the interpolation calculation.

In some embodiments, in response to obtaining blockage object data of at least one blockage point, the gas company management platform may update the gas operation map.

The blockage object data is data characterizing composition of a blockage object, and may include composition information of at least one composition causing the blockage, and a proportion of each composition.

In some embodiments, the at least one blockage point may be a node in the gas operation map or a point that does not belong to the gas operation map. In response to the at least one blockage point being a node in the gas operation map, the gas company management platform may add the corresponding blockage object data as a new node attribute to the gas operation map. In response to the at least one blockage point being a point that does not belong to the gas operation map, the gas company management platform may add the blockage point as a supplementary node to the gas operation map, determine a connection relationship between the supplementary node and other nodes based on a gas pipeline in which the blockage point is located, and determine a newly added edge between the supplementary node and original nodes in the gas operation map. The node attribute corresponding to the supplementary node may be the blockage object data corresponding to the blockage point, an edge feature corresponding to the newly added edge may be a length of the gas pipeline corresponding to the newly added edge.

Extending the nodes and the node attributes in the gas operation map based on the at least one blockage point in the gas pipeline and the corresponding blockage object data, a gas operation map with richer data can be obtained, thereby obtaining broader and more accurate determination result of the candidate blockage segments.

In some embodiments, in response to determining that the data completeness of the gas operation map satisfies the preset completeness condition, the gas company management platform may determine the candidate blockage segments based on the gas operation map, and in response to determining that the data completeness of the gas operation map does not satisfy the preset completeness condition, the gas company management platform may determine candidate blockage segments based on the updated map.

In some embodiments, the gas company management platform may determine the candidate blockage segments based on the node attributes of the nodes in the gas operation map or the updated map. For example, the gas company management platform may determine a node that have the monitoring data, the pipeline pressure is greater than the pressure threshold, and the gas flow rate is less than the flow rate threshold as a target node, and determine the target node and upstream and downstream pipelines thereof as the candidate blockage segments.

Because the gas operation map before updating is incomplete, the gas company management platform determines whether the gas operation map data before updating is complete by evaluating the data completeness. In some embodiments of the present disclosure, the gas operation map with insufficient data completeness is supplemented with data based on the gas operation map to obtain a more complete updated map; and the candidate blockage segments in the gas pipeline are determined based on the updated map, so as to obtain more extensive and accurate results.

In some embodiments, the gas company management platform may obtain the blockage detection result of the candidate blockage segments.

The blockage detection result refers to a data sequence used to reflect the blockage of the candidate blockage segments. In some embodiments, the blockage detection result may include an acoustic wave reflection duration sequence of at least one location of the candidate blockage segments.

In some embodiments, the gas company management platform may control an acoustic wave transmitting device outside the candidate blockage segments to transmit an acoustic wave signal, and capture and analyze a characteristic change of acoustic waves as the acoustic waves propagate inside the pipeline in terms of reflection, scattering, or attenuation using a the receiving device, so as to obtain the blockage detection result.

In some embodiments, the gas company management platform may determine a target blockage point location based on the blockage detection result. In some embodiments, the gas company management platform may determine, for each blockage detection result, a gradient of adjacent acoustic wave reflection durations in a sequence of acoustic wave reflectance durations, and use a location corresponding to a point with a largest change in the gradient as the target blockage point location of the candidate blockage segments.

In some embodiments, the target blockage point location may also include a predicted blockage point location that may generate blockage in the future.

In some embodiments, the gas company management platform may determine a predicted blockage point location 332 in a future time period based on a blockage detection result 330 through a blockage prediction model 331.

The blockage prediction model is a model for determining the predicted blockage point location and a corresponding blockage level in the future time period. In some embodiments, the blockage prediction model may be a machine learning model, such as a deep neural networks (DNN) model, etc.

In some embodiments, an input of the blockage prediction model may include the blockage detection result, and an output of the blockage prediction model may include the predicted blockage point location in the gas pipeline network in the future time period. The future time period may be set based on actual needs. More descriptions regarding the blockage detection result may be found in FIG. 2 and the related descriptions thereof.

The predicted blockage point location refers to at least one point location in the gas pipeline network where the blockage is likely to occur in the future time period.

The blockage level refers to a percentage of space inside the gas pipeline that is occupied by a blockage object. In some embodiments, the blockage level may be expressed as a numerical value. The larger the numerical value, the higher the blockage level.

In some embodiments, the blockage prediction model may be obtained by training an initial prediction model based on a large number of first training samples with first labels. The gas company management platform may input a plurality of first training samples with the first labels into the initial prediction model, construct a loss function based on the first labels and results of the initial prediction model, and iteratively update the initial prediction model based on the loss function. The model training may be completed when a preset condition is satisfied, and the blockage prediction model may be obtained. The preset condition may be that the loss function converges, a count of iterations reaches a threshold, etc.

In some embodiments, the first training samples may include a sample detection result of a sample blockage segment at a first historical time in the historical data. The sample detection result refers to a blockage detection result in the historical data.

In some embodiments, the first labels may include a historical blockage point location detected in the sample blockage segment at a second historical time in the historical data. The second historical time may be later than the first historical time.

In some embodiments of the present disclosure, the blockage prediction model allows for learning the pattern of blockage occurrence from the historical data, thereby improving the accuracy of predicting a future blockage event, and facilitating the early regulation of a possible blockage point to reduce the possibility of accidents.

In some embodiments of the present disclosure, the gas company management platform makes preliminary evaluation of potential blockage segments using the gas operation map, and obtain more accurate results by further detecting the internal condition of the potential blockage segments, thereby optimizing the maintenance operation.

FIG. 4 is a flowchart illustrating a process of determining a cleaning parameter according to some embodiments of the present disclosure. As shown in FIG. 4, a process 400 may include the following operations. In some embodiments, the process 400 may be performed by a processor of a gas company management platform or the gas company management platform.

In some embodiments, the processor may determine, based on at least one point location to be cleaned and a movement speed, a movement parameter, control a cleaning robot to clean the at least one point location to be cleaned based on the movement parameter; in response to the cleaning robot reaching the at least one point location to be cleaned, control the cleaning robot to perform preliminary cleaning according to a preset configuration; in response to obtaining cleaning data fed back from the cleaning robot, determine a configuration parameter based on the cleaning data; and generate a configuration update instruction based on the configuration parameter and send the configuration update instruction to the cleaning robot.

In some embodiments, controlling the cleaning robot to clean the point location to be cleaned based on the movement parameter may include: sending the movement parameter to the government safety supervision management platform; in response to obtaining a cleaning confirmation instruction from the government safety supervision management platform, generating a movement instruction based on the movement parameter and sending the movement instruction to the cleaning robot to control the cleaning robot to clean the at least one point location to be cleaned.

In 410, a movement parameter of a cleaning robot may be determined based on at least one point location to be cleaned and a movement speed, and the movement parameter may be sent to a government safety supervision management platform.

The movement parameter refers to a parameter used to characterize a movement feature of the cleaning robot. In some embodiments, the movement parameter may include the at least one point location to be cleaned and the movement speed. More descriptions regarding the at least one point location to be cleaned may be found in FIG. 2 and the related descriptions thereof.

The movement speed refers to a speed at which the cleaning robot moves through the gas pipeline network when performing cleaning operation.

In some embodiments, the gas company management platform may determine the movement speed of the cleaning robot based on prior experience or actual needs.

In some embodiments, the movement speed may be correlated with a distribution sparsity of the at least one point location to be cleaned in a region where the at least one point location to be cleaned is located. The greater the distribution sparsity, the slower the movement speed of the cleaning robot in the region.

The distribution sparsity refers to a level of sparsity of the distribution of the at least one point location to be cleaned. In some embodiments, the distribution sparsity may be expressed as a numerical value. The larger the numerical value, the sparser the distribution of the at least one point location to be cleaned, and the smaller the numerical value, the denser the distribution of the at least one point location to be cleaned.

In some embodiments, the gas company management platform may determine the distribution sparsity based on a point distance between the at least one point location to be cleaned. For example, the gas company management platform may obtain a point distance between every two point locations to be cleared of the at least one point location to be cleaned, and determine a mean value based on all the point distances corresponding to the at least one point location to be cleaned, and the mean value may be the distribution sparsity.

In some embodiments of the present disclosure, evaluating the movement speed based on the distribution sparsity helps improve the cleaning efficiency. The greater the distribution sparsity, the more dispersed the at least one point location to be cleaned, and the higher the probability of blockage between the at least one point location to be cleaned. By appropriately reducing the movement speed of the cleaning robot based on a relatively great distribution sparsity, the cleaning robot can clean more carefully between two point locations to be cleaned of the at least one point location to be cleaned.

In some embodiments, the processor of the gas company management platform may determine the movement parameter of the cleaning robot based on the at least one point location to be cleaned and the movement speed. For example, the gas company management platform may directly use the determined movement speed and the movement speed as the movement parameter.

In some embodiments, the gas company management platform may send the movement parameter to the smart gas equipment object platform via the gas company sensor network platform. More descriptions regarding the gas company management platform and the smart gas equipment object platform may be found in FIG. 1 and the related descriptions thereof.

In 420, in response to obtaining a cleaning confirmation instruction from the government safety supervision management platform, a movement instruction may be generated based on the movement parameter and the movement instruction may be sent to the cleaning robot to control the cleaning robot to clean the at least one point location to be cleaned.

The cleaning confirmation instruction refers to an instruction that confirms cleaning of the at least one point location to be cleaned.

In some embodiments, the gas company management platform may obtain the cleaning confirmation instruction from the government safety supervision management platform via the government safety supervision sensor network platform. More descriptions regarding the government safety supervision management platform and the government safety supervision sensor network platform may be found in FIG. 1 and the related descriptions thereof.

The movement instruction refers to an instruction for controlling the cleaning robot to move.

In some embodiments, in response to obtaining the cleaning confirmation instruction from the government safety supervision management platform, the gas company management platform may generate the movement instruction based on the movement parameter. For example, the processor generates the movement instruction based on the movement parameter by route planning. The movement instruction may include the at least one point location to be cleaned that the cleaning robot needs to reach, a sequence for cleaning the at least one point location to be cleaned, and a movement speed from a current point location to be cleaned to a next point location to be cleaned, or the like.

In some embodiments, the gas company management platform may send the movement instruction to the smart gas equipment object platform via the gas company sensor network platform to control the cleaning robot in the smart gas equipment object platform to reach the at least one point location to be cleaned based on the movement instruction, so as to clean the location where the blockage exists in the gas pipeline network. More descriptions regarding the smart gas equipment object platform may be found in FIG. 1 and the related descriptions thereof.

In 430, in response to the cleaning robot reaching the at least one point location to be cleaned, the cleaning robot may be controlled to perform preliminary cleaning according to a preset configuration.

The preset configuration refers to a preset cleaning configuration of the cleaning robot. In some embodiments, the preset configuration may include at least one of a preset cleaning intensity and a preset sweeping tool. The preset cleaning intensity refers to a preset intensity of cleaning. The preset sweeping tool refers to a preset tool for performing the cleaning.

In some embodiments, the preset cleaning intensity may be represented by a value ranging from 1 to 10. The larger the value, the higher the preset cleaning intensity. In some embodiments, the preset sweeping tool may include, but is not limited to, one or more of a brush, a scraper, a high-pressure nozzle, or the like.

In some embodiments, the preset configuration may be set based on prior experience.

The preliminary cleaning refers to a first round of cleaning performed by the cleaning robot at the at least one point location to be cleaned.

In some embodiments, the gas company management platform may send the preset configuration to the smart gas equipment object platform via the gas company sensor network platform to control the cleaning robot in the smart gas equipment object platform to perform the preliminary cleaning on the location where the blockage exists in the gas pipeline network according to the preset configuration.

In 440, in response to obtaining cleaning data fed back from the cleaning robot, a configuration parameter may be determined based on the cleaning data.

The cleaning data refers to data about the blockage situation that is fed back by the cleaning robot after the first round of cleaning at the at least one point location to be cleaned. In some embodiments, the cleaning data may include a distribution of blockage object composition at the at least one point location to be cleaned.

In some embodiments, the gas company management platform may determine the cleaning data by conducting composition analysis on a blockage object removed. The blockage object refers to an object that blocks the gas pipeline.

The configuration parameter refers to a parameter characterizing the configuration of the cleaning robot. In some embodiments, the configuration parameter may include at least one of the cleaning intensity and the sweeping tool. The cleaning intensity may be represented by a numerical value. The larger the numerical value, the greater the cleaning intensity. The type of the sweeping tool is similar to the preset sweeping tool, which may be found in the present disclosure above.

In some embodiments, in response to obtaining the cleaning data fed back from the cleaning robot, the gas company management platform may determine the configuration parameter based on the cleaning data in a plurality of ways.

For example, the gas company management platform may determine the configuration parameter of the cleaning robot based on the cleaning data by matching in a reference configuration database.

In some embodiments, the gas company management platform may determine candidate reference data based on the historical data of the gas pipeline network, and filter the candidate reference data according to a preset filtering criterion to determine reference data. The candidate reference data may include at least one piece of data characterizing a historical cleaning situation. The reference data may include at least one piece of filtered data characterizing the historical cleaning situation. Each piece of data may include a historical blockage level before cleaning, historical cleaning data, a historical configuration parameter, and a historical blockage level after cleaning.

The preset filtering criterion may include that a blockage level change rate is greater than a change rate threshold. The blockage level change rate may be determined based on a ratio of a blockage level change value of the at least one point location to be cleaned to an initial blockage level before cleaning. The blockage level change value may be determined based on a difference between the initial blockage level before cleaning and the historical blockage level after cleaning. The change rate threshold may be determined based on prior experience.

In some embodiments, the gas company management platform may construct at least one vector to be clustered based on the historical cleaning data in the reference data and the corresponding historical configuration parameter, and obtain a preset number of cluster centers by clustering the at least one vector to be clustered. The gas company management platform may determine the historical cleaning data corresponding to the cluster centers as reference cleaning data, and determine the historical configuration parameters corresponding to the cluster centers as reference configuration parameters. The preset count may be set based on prior experience and/or actual needs.

In some embodiments, the gas company management platform may construct a reference configuration database based on the reference cleaning data and the reference configuration parameters, obtain reference cleaning data with a highest similarity level to the cleaning data by matching in the reference configuration database based on the cleaning data fed back by the cleaning robot, and determine a reference configuration parameter corresponding to the reference cleaning data as the configuration parameter corresponding to the cleaning data.

In some embodiments, the gas company management platform ma obtain candidate configuration parameters based on the historical cleaning data; determine predicted cleaning effects of the candidate configuration parameters based on the cleaning data; and determine a candidate configuration parameter of which predicted cleaning effect satisfies a preset cleaning goal as the configuration parameter.

The historical data refers to data related to when the cleaning robot performs historical cleaning operations. In some embodiments, the historical data may include at least one piece of data characterizing the historical cleaning situation. Each piece of data may include a historical blockage level before cleaning, historical cleaning data, a historical configuration parameter, and a historical blockage level after cleaning.

The candidate configuration parameters are alternative configuration parameters.

In some embodiments, the gas company management platform may obtain at least one piece of alternative data by filtering the historical data according to the preset filtering criterion, and determine historical cleaning data in the at least one piece of alternative data with a count of occurrences greater than a count threshold as the candidate configuration parameter. More descriptions regarding the preset filtering criterion may be found in the preceding description.

The predicted cleaning effect refers to a predicted effect after cleaning. In some embodiments, the predicted cleaning effect may be represented by a value ranging from 1 to 10. The larger the value, the better the predicted cleaning effect.

In some embodiments, the gas company management platform may determine the predicted cleaning effects corresponding to the candidate configuration parameters in a plurality of ways.

For example, the processor may determine the predicted cleaning effect by querying a cleaning effect evaluation table based on the cleaning data and the candidate configuration parameters. The cleaning effect evaluation table may include at least one piece of reference evaluation data, and each piece of reference assessment data may include reference cleaning data, a reference configuration parameter, and a corresponding reference cleaning effect thereof.

In some embodiments, the cleaning effect evaluation table may be constructed based on reference data. For example, the gas company management platform may construct cleaning vectors based on the historical cleaning data, the historical configuration parameters, and the blockage level change rate in the reference data, obtain a preset count of cluster centers by clustering the cleaning vectors, determine the historical cleaning data and the historical configuration parameters corresponding to the cluster centers as the reference cleaning data and the reference configuration parameters, and determine the blockage level change rate corresponding to the cluster centers as the reference cleaning effect. More descriptions regarding obtaining the reference data may be found in the present disclosure above.

In some embodiments, the gas company management platform may determine the closest reference cleaning data and the reference configuration parameters by querying in the leaning effect evaluation table based on the cleaning parameter and the candidate configuration parameters, and determine the reference cleaning data and the reference configuration parameters corresponding to the reference cleaning effects as the predicted cleaning effects corresponding to the candidate configuration parameters.

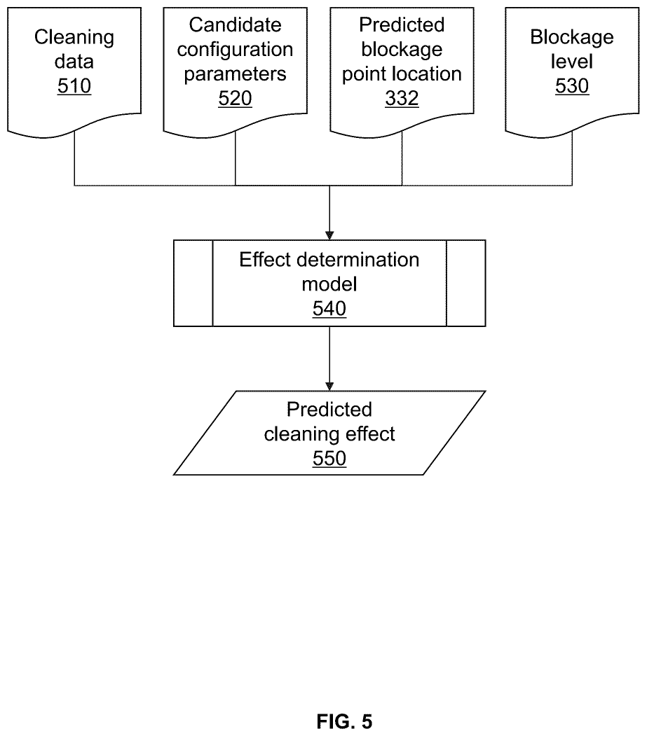

In some embodiments, the gas company management platform may determine, based on the cleaning data, the predicted cleaning effects of the candidate configuration parameters through an effect determination model. More descriptions regarding the effect determination model may be found in FIG. 5 and the related descriptions thereof.

In some embodiments, the gas company management platform may determine the configuration parameter based on the predicted cleaning effects of the candidate configuration parameters. For example, the gas company management platform may determine a candidate configuration parameter of which the predicted cleaning effect satisfies the preset cleaning goal as the configuration parameter.

The preset cleaning goal is a preset desired cleaning effect to be achieved. In some embodiments, the preset cleaning goal may be represented by the change rate threshold. When the blockage level change rate is greater than the change rate threshold, it is determine that the preset cleaning goal is achieved. The change rate threshold characterizes a minimum expected value of the blockage level change rate of the gas pipeline and/or the at least one point location to be cleaned. In some embodiments, the preset cleaning goal may be set based on prior experience and/or actual needs.

In some embodiments, the gas company management platform may determine a candidate configuration parameter of which the predicted cleaning effect is not less than the change rate threshold as the configuration parameter.

In some embodiments of the present disclosure, the candidate configuration parameters are determined based on the historical cleaning data, the cleaning effect is determined based on the cleaning parameter and the candidate configuration parameters, and the configuration parameter is further determined, which facilitates to select the configuration parameter with the optimal effect, thereby better guaranteeing the cleaning effect of the cleaning robot.

In 450, a configuration update instruction may be generated based on the configuration parameter, and the configuration update instruction may be sent to the cleaning robot.

The configuration update instruction refers to an instruction for updating the configuration of the cleaning robot.

In some embodiments, the processor may generate the corresponding configuration update instruction based on the configuration parameter to control the cleaning robot to update the relevant configuration.

In some embodiments, the processor may send the configuration update instruction based on the smart gas equipment object platform. More descriptions regarding the smart gas equipment object platform may be found in FIG. 1 and the related descriptions thereof.

In some embodiments of the present disclosure, the movement parameter is determined based on the at least one point location to be cleaned and the movement speed, the movement instruction is generated based on the movement parameter for controlling the cleaning robot to reach the at least one point location to be cleaned and controlling the cleaning robot to perform the preliminary cleaning based on the preset configuration. The configuration parameter is determined based on the cleaning data fed back from the cleaning robot, and the configuration update instruction is further determined, which ensures that the cleaning process is compliant and safe, and is conducive to determining the configuration update instruction that is suitable for pipeline cleaning, ensures that the optimal sweeping tool and the cleaning intensity are used, and reduces unnecessary cleaning of the cleaning robot, thereby avoiding the destruction of the gas pipeline while maintaining energy conservation and high efficiency.

It should be noted that the foregoing descriptions of the process 200 and the process 400 are intended to be exemplary and illustrative only and does not limit the scope of application of the present disclosure. For a person skilled in the art, various corrections and changes can be made to the process 200 and the process 400 under the guidance of the present disclosure. However, these corrections and changes remain within the scope of the present disclosure.

FIG. 5 is a schematic diagram illustrating an effect determination model according to some embodiments of the present disclosure.

In some embodiments, the gas company management platform may determine predicted cleaning effects of candidate configuration parameters based on cleaning data through an effect determination model.

More descriptions regarding the cleaning data, the candidate configuration parameters, and the predicted cleaning effects may be found in FIG. 2 and the related descriptions thereof.

The effect determination model is a model for determining the predicted cleaning effect. In some embodiments, the effect determination model may be a machine learning model, such as a deep neural network (DNN), a graph neural network (GNN), etc.

In some embodiments, as shown in FIG. 5, an input of an effect determination model 540 may include cleaning data 510 and candidate configuration parameters 520, and an output of the effect determination model 540 may include a predicted cleaning effect 550.

In some embodiments, the effect determination model may be obtained by training in a plurality of ways. For example, the effect determination model may be obtained by training an initial determination model based on a large number of training samples with training labels. A set of training samples for training the effect determination model may include sample cleaning data and sample configuration parameters, and the training labels corresponding to the training samples are historical cleaning effects when cleaning is performed based on the sample cleaning data and sample configuration parameters.

In some embodiments, the training samples and the corresponding training labels may be obtained based on historical data. For example, historical cleaning data and historical configuration parameters corresponding to at least one cleaning operation in the historical data may be obtained and a historical cleaning effect may be determined based on a difference between a blockage level before cleaning and a blockage level after cleaning. The gas company management platform may determine the historical cleaning data and the historical configuration parameters as the sample cleaning data and the sample configuration parameters, and determine the historical cleaning effects as the training labels. More description regarding the blockage level may be found in the present disclosure above.

In some embodiments, the gas company management platform may perform a plurality iterative training of an initial effect determination model based on the plurality of training samples with the training labels. The process of training is similar to the process of training the blockage prediction model, which may be found in FIG. 3 and the related descriptions thereof.

In some embodiments, as shown in FIG. 5, the input of the effect determination model 540 may further include the predicted blockage point location 332 and a corresponding blockage level 530 in a future time period.

More descriptions regarding the predicted blockage point location and the blockage level may be found in FIG. 3 and the related descriptions thereof.

In some embodiments, the training samples for training the effect determination model may further include a sample blockage point location and a sample blockage level. The sample blockage point location and the sample blockage level may be obtained based on the historical data.

In some embodiments, the gas company management platform may train the effect determination model based on the training samples including the sample blockage point location, the sample blockage level, the sample cleaning data, and the sample candidate configuration parameters. More descriptions regarding training the effect determination model may be found in the present disclosure above.

In some embodiments of the present disclosure, the blockage point location and the blockage level are used as the input of the effect determination model, which can consider the generation rate of the blockage object in the gas pipeline and thus improve the accuracy of the effect determination model in determining the cleaning effect, and provide more accurate reference data for the subsequent cleaning operation, making the cleaning more effective.

In some embodiments, the gas company management platform may obtain a training set, a verification set, and a test set by splitting a sample data set according to a preset proportion; and obtain the effect determination model by training the initial effect determination model using the training set, the verification set, and the test set.

The preset proportion refers to a preset proportion of the training set, the verification set, and the test set to the sample data set. For example, the proportion of the training set, the verification set, and the test set to the sample data set may be 8:1:1.

In some embodiments, the preset proportion may be preset by the gas company management platform based on default settings or prior experience.

The sample data set is historical data used as the training samples. In some embodiments, the sample data set may include historical cleaning data and historical configuration parameters corresponding to the gas pipeline in at least one historical time period.

In some embodiments, the sample data set may be extracted from a storage device by the gas company management platform based on default settings or prior experience.

In some embodiments, the processor may obtain the training set, the verification set, and the test set by splitting the sample data set based on the preset proportion.

The process of splitting may include sampling statistics, which may include, but is not limited to, random sampling, stratified sampling, or the like. In some embodiments, the gas company management platform may split the sample data set in other ways.

The training set is a data set for training the effect determination model.

The test set is a data set for evaluating the performance of the effect determination model.

The verification set is a data set for selecting the effect determination model with an optimal effect.

The training set, the verification set, and the test set obtained by splitting have no data crossover. That is, any two of the training set, the verification set, and the test set have no duplicate data.

In some embodiments, the gas company management platform may obtain the effect determination model by training the initial effect determination model based on the training set, the verification set, and the test set. The process of training may include a plurality of stages of training. One stage of the training may include: inputting the training set into the initial effect determination model, constructing a loss function based on the training labels and outputs of the initial effect determination model, and updating parameters of the initial effect determination model through a plurality of iterations based on the loss function. In the training process, a trained initial effect determination model may be verified by the verification set based on a preset verification frequency, and an initial learning rate or a learning rate in the training process of the initial effect determination model after the round of training may be adjusted based on a verification result. The learning rate may be adjusted in various ways, such as one or more of a learning rate attenuation strategy, learning rate preheat, a cyclic learning rate, an adaptive learning rate adjustment algorithm, etc.

The verification frequency refers to a frequency of verifying the initial effect determination model after training. For example, the model is verified every n iterations of training; in response to satisfying a verification condition, an intermediate model is obtained, and the intermediate model tested via the test set to evaluate the performance of the intermediate model obtained by the stage of training. The intermediate model refers to an effect determination model obtained after the stage of training. The performance of the intermediate model refers to an accuracy rate output by the intermediate model. The verification condition refers to a condition for verifying a current training result, which may include one or more of a count of iterations reaching a threshold, a loss function converging, and a value of the loss function being less than a preset threshold. A plurality of stages of training is performed, and the effect determination model with the optimal performance is used as the trained effect determination model.

The learning rate is a parameter that controls a step size when the model parameters are updated during model training, which determines a magnitude of parameter updating along a direction where the loss function decreases the fastest during the training of the initial effect determination model by gradient descent (or other optimization algorithms).

In some embodiments, different initial learning rates may be used for model training using different sample data sets. The initial learning rate of each sample data set is related to a sample statistical difference of the sample data set. In some embodiments, the gas company management platform may determine the initial learning rate of the effect determination model based on the sample statistical difference. For example, the greater the sample statistical difference, the smaller the initial learning rate.

Usually, the greater the sample statistical difference, the higher the uncertainty of the cleaning result of the pipeline, the larger the influence of potential factors. Accordingly, for such samples, a smaller learning rate is determined so as to better explore the implied patterns in the samples.

The sample statistical difference refers to a difference level of the samples in the sample data set. In some embodiments, the greater the sample statistical difference, the greater the diversity of the samples in the sample data set.

In some embodiments, the gas company management platform may determine the sample statistical difference in plurality of ways. For example, the gas company management platform may quantify the cleaning data, the configuration parameter, and the cleaning effect of each piece of sample data in the sample data set as a numerical value, and correspond each sample data to a numerical vector. A plurality of vector distances (e.g., a cosine distance) between every two numerical vectors in the sample data set may be obtained, and a variance of the plurality of vector distances may be determined. The larger the variance, the greater the sample statistical difference.

In some embodiments of the present disclosure, the effect determination model is trained based on the training set, the test set, and the verification set, so as to improve the robustness of the effect determination model, prevent the effect determination model from overfitting, and appropriately increase the learning rate when the sample statistical difference is too large, which makes the model learn sufficiently, and helps accurate acquisition of the cleaning effect.

In some embodiments of the present disclosure, the cleaning effect is determined through the effect determination model based on the cleaning data and the configuration parameter, so that the cleaning effect can be accurately evaluated based on the learning capability of the machine learning model, thereby improving the blockage cleaning efficiency of the gas pipeline.

One or more embodiments of the present disclosure provide a non-transitory computer-readable storage medium, comprising computer instructions that, when read by a computer, may direct the computer to implement the method for pipeline blockage point localization of smart gas.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for pipeline blockage point localization of smart gas, implemented based on a gas company management platform of an Internet of Things (IoT) system for pipeline blockage point localization of smart gas, comprising:
determining a monitoring point based on a historical blockage point set, the monitoring point being located in a gas pipeline of a gas pipeline network, the historical blockage point set being determined based on historical blockage data corresponding to a preset historical time period;
constructing a gas operation map based on monitoring data corresponding to the monitoring point, the monitoring data including at least one of a pipeline pressure and a gas flow rate;
determining a target blockage point location based on the gas operation map;
determining a cleaning parameter based on the target blockage point location, the cleaning parameter including at least one point location to be cleaned; and
generating a cleaning instruction based on the cleaning parameter and sending the cleaning instruction to a cleaning robot to clean a gas pipeline corresponding to the at least one point location to be cleaned.

2. The method of claim 1, wherein a duration of the preset historical time period is determined based on an accident feature of a preset historical accident in the gas pipelines.

3. The method of claim 1, wherein the determining a target blockage point location based on the gas operation map includes:
determining candidate blockage segments based on the gas operation map;
obtaining a blockage detection result of the candidate blockage segments; and
determining the target blockage point location based on the blockage detection result.

4. The method of claim 3, further comprising:
determining, based on the blockage detection result, a predicted blockage point location in a future time period through a blockage prediction model; the blockage prediction model being a machine learning model.

5. The method of claim 3, wherein the determining candidate blockage segments based on the gas operation map includes:
evaluating data completeness of the gas operation map, in response to determining that the data completeness does not satisfy a preset completeness condition:
determining a data request and sending the data request to a government safety supervision management platform to obtain supplementary data;
obtaining an updated map by updating the gas operation map based on an obtaining condition of the supplementary data; and
determining the candidate blockage segments based on the updated map.

6. The method of claim 5, wherein the preset completeness condition includes that the data completeness is not less than a completeness threshold; the completeness threshold being related to an area of a region wherein the gas pipeline network is located.

7. The method of claim 5, further comprising:
in response to obtaining blockage object data of at least one blockage point, updating the gas operation map.

8. The method of claim 1, wherein the determining a cleaning parameter based on the target blockage point location includes:
determining, based on the at least one point location to be cleaned and a movement speed, a movement parameter of the cleaning robot, and sending the movement parameter to the government safety supervision management platform;
in response to obtaining a cleaning confirmation instruction from the government safety supervision management platform, generating a movement instruction based on the movement parameter and sending the movement instruction to the cleaning robot to control the cleaning robot to clean the at least one point location to be cleaned;
in response to the cleaning robot reaching the at least one point location to be cleaned, controlling the cleaning robot to perform preliminary cleaning according to a preset configuration; the preset configuration including at least one of a preset cleaning intensity and a preset sweeping tool;
in response to obtaining cleaning data fed back from the cleaning robot, determining a configuration parameter based on the cleaning data; the configuration parameter including at least one of the preset cleaning intensity and the preset sweeping tool; and
generating a configuration update instruction based on the configuration parameter and sending the configuration update instruction to the cleaning robot.

9. The method of claim 8, wherein the movement speed is related to a distribution sparsity of the at least one point location to be cleaned in a region where the at least one point location to be cleaned is located.

10. The method of claim 8, wherein the determining a configuration parameter based on the cleaning data includes:
obtaining candidate configuration parameters based on historical data;
determining predicted cleaning effects of the candidate configuration parameters based on the cleaning data; and
determining a candidate configuration parameter of which the predicted cleaning effect satisfies a preset cleaning goal as the configuration parameter.

11. The method of claim 10, wherein the determining predicted cleaning effects of the candidate configuration parameters based on the cleaning data includes:
determining the predicted cleaning effects of the candidate configuration parameters based on the cleaning data through an effect determination model; the effect determination model being a machine learning model.

12. The method of claim 11, further comprising:
obtaining a training set, a verification set, and a test set by splitting a sample data set according to a preset proportion; the sample data set including historical cleaning data and historical configuration parameters corresponding to the gas pipeline in at least one historical time period;
obtaining the effect determination model by training an initial effect determination model using the training set, the verification set, and the test set; wherein,
a learning rate corresponding to the sample data set is related to a sample statistical difference of the sample data set.

13. The method of claim 9, wherein an input of the effect determination model includes a predicted blockage point location in a future time period and a blockage level corresponding to the predicted blockage point location.

14. An Internet of Things (IoT) system for pipeline blockage point localization of smart gas, wherein the system comprises a government safety supervision management platform, a government safety supervision sensor network platform, a gas company management platform, a gas company sensor network platform, and a smart gas equipment object platform;
the smart gas equipment object platform includes a cleaning robot and a monitoring device; the cleaning robot is configured to clean a gas pipeline of a gas pipeline network; the monitoring device is configured at a location of a monitoring point in the gas pipeline for obtaining monitoring data corresponding to the monitoring point, the monitoring point being located in the gas pipeline of the gas pipeline network;
the gas company management platform is configured to:
obtain the monitoring data corresponding to the monitoring point from the smart gas equipment object platform through the gas company sensor network platform, and upload the monitoring data to the government safety supervision management platform through the government safety supervision sensor network platform;
construct a gas operation map based on the monitoring data corresponding to the monitoring point, the monitoring data including at least one of a pipeline pressure and a gas flow rate;
determine a target blockage point location based on the gas operation map;
determine a cleaning parameter based on the target blockage point location, the cleaning parameter including at least one point location to be cleaned; and
generate a cleaning instruction based on the cleaning parameter and send the cleaning instruction to the cleaning robot through the smart gas equipment object platform to clean a gas pipeline corresponding to the at least one point location to be cleaned.

15. The IoT system of claim 14, wherein the gas company management platform is further configured to:
determine candidate blockage segments based on the gas operation map;
obtain a blockage detection result of the candidate blockage segments; and
determine the target blockage point location based on the blockage detection result.

16. The IoT system of claim 15, wherein the gas company management platform is further configured to:
evaluate data completeness of the gas operation map, in response to determining that the data completeness does not satisfy a preset completeness condition:
determine a data request and send the data request to the government safety supervision management platform to obtain supplementary data;
obtain an updated map by updating the gas operation map based on an obtaining condition of the supplementary data; and
determine the candidate blockage segments based on the updated map.

17. The IoT system of claim 16, wherein the gas company management platform is further configured to:
in response to obtaining blockage object data of at least one blockage point, update the gas operation map.

18. The IoT system of claim 1, wherein the gas company management platform is further configured to:
determine, based on the at least one point location to be cleaned and a movement speed, a movement parameter of the cleaning robot, and send the movement parameter to the government safety supervision management platform;
in response to obtaining a cleaning confirmation instruction from the government safety supervision management platform, generate a movement instruction based on the movement parameter and send the movement instruction to the cleaning robot to control the cleaning robot to clean the at least one point location to be cleaned;
in response to the cleaning robot reaching the at least one point location to be cleaned, control the cleaning robot to perform preliminary cleaning according to a preset configuration; the preset configuration including at least one of a preset cleaning intensity and a preset sweeping tool;
in response to obtaining cleaning data fed back from the cleaning robot, determine a configuration parameter based on the cleaning data; the configuration parameter including at least one of the preset cleaning intensity and the preset sweeping tool; and
generate a configuration update instruction based on the configuration parameter and send the configuration update instruction to the cleaning robot.

19. The IoT system of claim 18, wherein the gas company management platform is further configured to:
obtain candidate configuration parameters based on historical data;
determine predicted cleaning effects of the candidate configuration parameters based on the cleaning data; and
determine a candidate configuration parameter of which the predicted cleaning effect satisfies a preset cleaning goal as the configuration parameter.

20. A non-transitory computer-readable storage medium, comprising computer instructions that, when read by a computer, direct the computer to implement the method of claim 1.
